(19) United States
(12) Patent Application Publication
(10) Pub. No.: US 2004/0127579 A1
(43) Pub. Date: Jul. 1, 2004

(54) Supension obtained from a multiple emulsion comprising a hydrophobic compound solid at room temperature and granules obtained by drying said suspension

(76) Inventors: Helene Lannibois-Drean, Charenton Le Pont (FR); Anne-Gilles Dreno, Sevran (FR)

Correspondence Address: Jean-Louis Seugnet, Rhodia Inc, Intellectual Property Department, 259 Prospect Plains Road CN 7500, Cranbury, NJ, 08512-7500, US

(21) Appl. No.: 10/473,542

(22) PCT Filed: Apr. 11, 2002
(86) PCT No.: PCT/FR02/01271

(30) Foreign Application Priority Data
Apr. 12, 2001 (FR) 0105035

(51) Int. Cl. B01F 17/00

(52) U.S. Cl. 516/21

(57) ABSTRACT

The invention concerns a suspension of particles in an aqueous medium, obtainable by carrying out the following steps: (a) preparing an invert emulsion from an internal aqueous phase comprising at least an active hydrophilic substance, and an internal organic phase comprising at least a hydrophobic compound having a melting point not less than 35° C., at least a non-ionic or cationic surfactant and/or at least a non-ionic or cationic amphiphilic polymer; the temperature for preparing the emulsion being not less than the melting point of the hydrophobic compound; (b) preparing the multiple emulsion by dispersing the invert emulsion in an external aqueous phase comprising at least a non-ionic polyalkoxylated surfactant and/or at least a non-ionic polyalkoxylated amphiphilic polymer and at least an anionic surfactant; the temperature for carrying out the dispersion being not less than the melting point of the hydrophobic compound; (c) bringing said resulting emulsion to a temperature not higher than the melting point of the hydrophobic compound. The invention also concerns granules obtainable by contacting said suspension with at least a drying agent. Finally, the invention further concerns the use of said suspension and said granules.

The present invention relates to a suspension which can be obtained from a multiple emulsion, i.e. from a water-in-oil inverse emulsion dispersed in an aqueous phase; the inverse emulsion comprising, as continuous organic phase, a hydrophobic compound which is solid at ambient temperature and which has more particularly a melting point greater than or equal to 35° C. Similarly, it relates to granules which can be obtained by drying said suspension, and also to the use of the suspension and of the granules.

Given the increasing number of formulations comprising several active materials, the problems associated with the compatibility of the active materials with one another have themselves also increased.

In many fields, it is increasingly proposed to simplify the conditions for use of formulations by introducing into said formulations all the necessary ingredients, including the reactive compounds. In this way, at the desired time, the user merely has to place the formulation under the conditions in which it reacts. The difficulty is in finding the suitable condition(s) for triggering this reaction, and in being able to control the effects thereof so as to allow a reaction which is more or less rapid depending on the rate of release, in the formulation, of the active element.

A subject of the present invention is compositions in the form of suspensions or of granules, comprising at least one active material. These compositions can, depending on the use of suitable initiators, release the active material(s) which they contain, in a controlled manner.

A first subject of the invention therefore consists of a suspension of particles in an aqueous medium, which can be obtained by carrying out the following steps:

(a) a water-in-oil inverse emulsion is prepared from an internal aqueous phase comprising at least one hydrophilic active material, and an internal organic phase comprising at least one hydrophobic compound having a melting point of greater than or equal to 35° C., at least one nonionic or cationic surfactant and/or at least one nonionic or cationic amphiphilic polymer; the temperature for preparing the emulsion being greater than or equal to the melting point of the hydrophobic compound;

(b) the multiple emulsion is prepared by dispersing the inverse emulsion in an external aqueous phase comprising at least one nonionic polyalkoxylated surfactant and/or at least one nonionic polyalkoxylated amphiphilic polymer and at least one anionic surfactant; the temperature at which the dispersion is carried out being greater than or equal to the melting point of the hydrophobic compound;

(c) the multiple emulsion obtained is brought to a temperature less than or equal to the melting point of the hydrophobic compound.

A second subject of the invention is represented by granules which can be obtained from the abovementioned suspension, by bringing said suspension into contact with at least one drying agent, in a step (d).

Finally, a subject of the invention is the use of the suspension and/or of the granules, as an additive in formulations intended for the fields of cosmetics, dental hygiene, foodstuffs, plant-care, the exploitation of oil or gas fields, and papermaking, and also of such formulations.

The suspension according to the invention has the advantage of being stable in the sense, in particular, that the liquid active material trapped in the solid organic particles remains substantially located in said particles. This stability of the system confers many advantages on the invention, both in terms of the very quality of the suspension and of the granules which can be prepared from said suspension, and in terms of the preparation of the suspension itself. In fact, due to this stability, it is not necessary to prepare said suspension over very short periods (less than a minute) in order to avoid any transfer of the hydrophilic active material from the internal aqueous phase to the external aqueous phase. A first consequence of this is that the suspension according to the invention can be prepared using simple and industrializable means, such as reactors in which the stirring is carried out by means of a frame paddle for example. A second consequence is that the cooling step (c) can be performed quite simply by leaving the multiple emulsion to cool down. It is therefore not necessary to implement annealing of the emulsion.

Another advantage of the suspension and of the granules according to the invention is that they make it possible to obtain compositions encapsulating an aqueous phase comprising a high content of active compound and which has a high ionic strength. It is well known that once it is desired to prepare a multiple emulsion, it is necessary to equilibrate the osmotic pressures of the internal and external aqueous phases so as to obtain a stable multiple emulsion. Now, when the ionic strength is very high, it is virtually impossible to equilibrate the osmotic pressures while at the same time conserving an emulsion that can be handled. In the case of the present invention, the equilibrium between the osmotic pressures is no longer necessary.

The granules according to the invention have the advantage of being stable when stored. Specifically, the granules do not release the active material(s) which they contain.

In addition, when the formulation in which they are employed is used, the granules according to the invention are capable of withstanding the conditions for use (relatively high pressure and/or shearing) and of not releasing the active material in an uncontrolled manner.

In addition, the granules, depending on the use made of the formulation into which they are introduced, make it possible to have a controlled release of the active material(s). This phenomenon is possible in particular by controlling the temperature for use of the formulation comprising the granules according to the invention. Thus, a slow diffusion of the active material may be observed if, at the temperature for use of the formulation, the granules are in a solid form. In such a case, the diffusion of said active material will therefore depend on the coefficient of diffusion thereof through the solid organic matrix and then through the walls of the granule.

Moreover, a rapid diffusion of the active material may be triggered by bringing the temperature of the formulation to a temperature greater than the melting point of the hydrophobic compound present in the granule.

However, other aims and advantages will emerge more clearly on reading the description and the example which follow.

In the description, the term “polymer” denotes both homopolymers and copolymers.

The first step of the process by which the suspension according to the invention can be obtained consists in preparing an inverse emulsion (water-in-oil)—step (a)—.

It should be noted that, in the remainder of the description, the aqueous phase of this inverse emulsion will be referred to as internal aqueous phase, and the organic phase will be referred to as internal organic phase.

As was mentioned previously, the internal aqueous phase comprises at least one hydrophilic active material.

It should be noted that said hydrophilic active material may be in a liquid form; in a form solubilized in a water-miscible solvent such as ethanol, propylene glycol or glycerol; in the form of a dispersed solid. The use of several active materials, in one or more forms, would not depart from the context of the present invention.

The total amount of hydrophilic active material is more particularly between 0.1 and 70% by weight of the internal aqueous phase, and preferably between 0.1 and 50% by weight of the internal aqueous phase.

Given the large number of fields in which the granules according to the invention may be used, many active materials may be suitable for implementing the invention.

By way of example of active materials which can be used, inter alia, in the cosmetics field, mention may in particular be made of α-hydroxy acids, such as citric acid, lactic acid, glycolic acid and salicylic acid in particular; hydrophilic vitamins, such as vitamin C and its derivatives; biocides; and also moisturizers, such as, for example, glycerol, urea, hyaluronic acid, allantoin, aloes, or plant extracts from terrestrial and marine plants.

In the food sector, mention may be made, for example, of crosslinking agents for texturing polymers, such as alginates or carrageenans, inter alia, chosen from divalent calcium salts.

In the field of plant-care, use may be made of hydrophilic pesticides or hydrophilic nutritive elements which promote plant growth and development.

As regards the field for the exploitation or construction of oil or gas wells, the present invention may be used for hydrophilic active materials which can be used in particular during operations of cementation, completion, drilling and stimulation of wells (for example fracturing). By way of examples of active materials which can be used in this field, mention may be made of catalysts for crosslinking of cement-based compositions, such as, for example, lithium salts, for instance the chloride and the acetate. Mention may similarly be made of compounds capable, inter alia, of degrading polysaccharides, such as, for example, carboxylic acids (in particular citric acid), enzymes (in particular cellulases) or oxidants.

In the field of silicones, mention may be made of crosslinking agents such as, for example, calcium salts or potassium hydroxide.

By way of active materials which are suitable in the papermaking field, mention may in particular be made of calcium chloride and hydrochloric acid.

As regards the internal organic phase, it comprises at least one hydrophobic compound having a melting point greater than or equal to 35° C. Preferably, the melting point is less than or equal to 100° C.

It should be noted that this hydrophobic compound represents the internal organic phase.

More particularly, said hydrophobic compound is chosen from the compounds exhibiting a water-solubility of less than 10% by weight, more particularly less than 5% by weight, preferably less than 1% by weight, whatever the form in which the compound exists (in solid form or in the molten state).

According to a preferred embodiment of the invention, said hydrophobic compound is chosen from: + waxes or fats of animal or plant origin, mineral waxes. By way of examples, mention may be made of waxes of animal origin such as beeswax, and waxes of plant origin such as carnauba wax and cocoa butter. Similarly, use may be made of animal fats such as pig or sheep fats, for example. As mineral wax, mention may be made, by way of illustration, of paraffin waxes; + saturated or unsaturated C₁₄-C₄₀ mono- or polycarboxylic acids, optionally comprising one or more hydroxyl groups; mono- or polyesters of C₁₄-C₄₀ mono- or polycarboxylic acids, optionally comprising one or more hydroxyl groups; saturated or unsaturated mono- or polyalcohols, comprising 14 to 40 carbon atoms. It should be noted that the alcohols from which the esters derive may comprise 1 to 40 carbon atoms and may comprise one or more esterified or nonesterified hydroxyl functions. By way of example of this type of compound, mention may be made, for example, of palmitic acid, stearic acid and behenic acid, the alcohols corresponding to these acids, and also the esters of such acids, such as the mono-, di- or triglycerides; + synthetic resins or gums such as silicone gums or resins, alkyd resins or epoxy resins; tackifying resins.

The internal organic phase may consist of one or more hydrophobic compounds.

The internal organic phase may optionally comprise at least one hydrophobic active material, as long as it is compatible with the hydrophilic active material present in the internal aqueous phase.

The hydrophobic active material is more particularly chosen from compounds the water-solubility of which does not exceed 10% by weight at 25° C.

It may be equally in liquid form, in a form solubilized in an organic solvent miscible with the internal organic phase, or else in the form of a dispersed solid. However, it is more advantageous to use an active material not solubilized in a solvent. In addition, it is preferable to choose it from compounds solid at ambient temperature and, advantageously, from those having a melting point of greater than or equal to 35° C.

Should the internal organic phase comprise one or more hydrophobic active materials, their content generally represents no more than 50% by weight of said internal organic phase.

When the active material is liquid at ambient temperature or has a melting point of less than 30° C., the content of active material preferably represents no more than 10% by weight of the internal organic phase.

Finally, it should be noted that it is not impossible for the organic phase itself to be considered as hydrophobic active material.

The internal organic phase also comprises at least one nonionic or cationic surfactant and/or at least one nonionic or cationic amphiphilic polymer.

More particularly, the nonionic surfactant and/or the nonionic amphiphilic polymer present in the internal organic phase is(are) chosen from those which satisfy the Bancroft rule conditions (2nd World Emulsion Congress, 1997, Bordeaux, France). More particularly, they are chosen from those which satisfy at the same time the two conditions below:

when they are mixed with the internal organic phase, at a concentration of between 0.1 and 15% by weight of said phase at 25° C., they are in the form of a solution in all or part of the concentration range indicated;

when they are mixed with the internal aqueous phase, at a concentration of between 0.1 and 15% by weight of said phase and at 25° C., they are in the form of a dispersion in all or part of the concentration range indicated.

Preferably, the nonionic surfactant has an HLB (hydrophilic/lipophilic balance) value of less than or equal to 8.

By way of examples of surfactants which can be part of the composition of the inverse emulsion, mention may be made of the surfactants, alone or as a mixture, chosen from:

alkoxylated fatty alcohols

alkoxylated triglycerides

alkoxylated fatty acids

optionally alkoxylated sorbitan esters

alkoxylated fatty amines

alkoxylated di(1-phenylethyl)phenols

alkoxylated tri(1-phenylethyl)phenols

alkoxylated alkylphenols

the number of alkoxylated (ethoxylated, propoxylated or butoxylated) units is such that the HLB value is less than or equal to 8.

The alkoxylated fatty alcohols generally comprise from 6 to 22 carbon atoms, the alkoxylated units being excluded from these numbers.

The alkoxylated triglycerides may be triglycerides of plant or animal origin.

The optionally alkoxylated sorbitan esters are fatty acid esters of cyclized sorbitol, the fatty acid comprising from 10 to 20 carbon atoms, such as lauric acid, stearic acid or oleic acid.

The alkoxylated fatty amines generally comprise from 10 to 22 carbon atoms, the EO and PO units being excluded from these numbers.

The alkoxylated alkylphenols generally contain one or two linear or branched alkyl groups having 4 to 12 carbon atoms. By way of example, mention may in particular be made of octyl, nonyl or dodecyl groups.

As regards the amphiphilic polymer, it advantageously comprises at least two blocks, and more particularly at least one hydrophobic block and at least one neutral hydrophilic block.

When the amphiphilic polymer comprises at least three blocks, and more particularly three blocks, the polymer is preferably linear. In addition, the hydrophobic blocks are more particularly at the ends.

When the polymers comprise more than three blocks, these polymers are preferably in the form of grafted or comb polymers.

In the text hereinbelow, even though this constitutes misuse of the language, the term “amphiphilic block polymer” will be used equally for the linear block polymers and for the grafted or comb polymers.

Said amphiphilic polymers may advantageously be obtained by “living” or controlled free-radical polymerization. By way of nonlimiting examples of “living” or controlled polymerization processes, reference may in particular be made to applications WO 98/58794 (xanthate), WO 98/01478 (dithioesters), WO 99/03894 (nitroxides) and WO 99/31144 (dithiocarbamates).

The amphiphilic polymers may also be obtained by anionic polymerization.

They may similarly be prepared by using ring-opening polymerizations (in particular anionic or cationic polymerizations), or by chemical modification of the polymer.

The grafted or comb polymers may also be obtained by “direct grafting” and copolymerization methods.

Direct grafting consists in polymerizing the chosen monomer(s) via a free-radical route, in the presence of the selected polymer so as to form the skeleton of the final product. If the monomer/skeleton couple and the operating conditions are carefully chosen, then there may be a transfer reaction between the growing macroradical and the skeleton. This reaction generates a radical on the skeleton and it is from this radical that the graft grows. The primary radical derived from the initiator may also contribute to the transfer reactions.

As regards copolymerization, this involves, in a first stage, the grafting, onto the end of the future pendent segment, of a free-radical-polymerizable function. This grafting may be performed by usual methods of organic chemistry. Next, in a second stage, the macromonomer thus obtained is polymerized with the chosen monomer to form the skeleton, and a “comb” polymer is obtained.

Among the hydrophobic monomers from which the hydrophobic block(s) of the amphiphilic may be prepared, mention may in particular be made of:

linear, branched, cyclic or aromatic monocarboxylic or polycarboxylic acid esters, comprising at least one ethylenic unsaturation, preferably comprising 8 to 30 carbon atoms, optionally bearing a hydroxyl group;

α,β-ethylenically unsaturated nitriles, vinyl ethers, vinyl esters, vinylaromatic monomers, and vinyl or vinylidene halides;

linear or branched, aromatic or nonaromatic hydrocarbon-based monomers, comprising at least one ethylenic unsaturation;

monomers of cyclic or noncyclic siloxane type, and chlorosilanes;

propylene oxide or butylene oxide;

alone or as mixtures, and also the macromonomers derived from such monomers.

By way of particular examples of hydrophobic monomers which may be included in the preparation of the hydrophobic block(s) of the amphiphilic block polymer, mention may be made of:

esters of (meth)acrylic acid with an alcohol comprising 1 to 12 carbon atoms, such as methyl, (meth)acrylate, ethyl (meth)acrylate, propyl (meth)acrylate, n-butyl (meth)acrylate, t-butyl (meth)acrylate, isobutyl (meth)acrylate or 2-ethylhexyl acrylate;

vinyl acetate, vinyl Versatate®, vinyl propionate, vinyl chloride, vinylidene chloride, methyl vinyl ether or ethyl vinyl ether;

vinyl nitriles more particularly including those having from 3 to 12 carbon atoms, such as in particular acrylonitrile or methacrylonitrile;

styrene, α-methylstyrene, vinyltoluene, butadiene, isoprene and chloroprene;

alone or as mixtures, and also the macromonomers derived from such monomers.

The preferred monomers are esters of acrylic acid with linear or branched C₁-C₄ alcohols, such as methyl, ethyl, propyl or butyl acrylate, vinyl esters, such as vinyl acetate, styrene or α-methylstyrehe.

As regards the nonionic hydrophilic monomers, from which the amphiphilic block polymers may be obtained, mention may be made, without wishing to be limited thereto, of ethylene oxide, linear, branched, cyclic or aromatic monocarboxylic or polycarboxylic acid amides, comprising at least one ethylenic unsaturation or derivatives, such as (meth)acrylamide, N-methylol(meth)acrylamide; hydrophilic esters derived from (meth)acrylic acid, such as, for example, 2-hydroxyethyl (meth)acrylate; vinyl esters allowing the production of polyvinyl alcohol blocks after hydrolysis, such as vinyl acetate, vinyl Versatate® or vinyl propionate, alone or in combination, and also the macromonomers derived from such monomers. It is recalled that the term “macromonomer” denotes a macromolecule bearing one or more polymerizable functions.

However, the preferred hydrophilic monomers are acrylamide and methacrylamide, alone or as a mixture, or in the form of macromonomers.

Preferably, the amphiphilic block polymers have a weight-average molar mass of less than or equal to 100 000 g/mol, more particularly between 1 000 and 50 000 g/mol, preferably between 1 000 and 20 000 g/mol. It is specified that the weight-average molar masses indicated above are theoretical molar masses, evaluated as a function of the respective amounts of the monomers introduced during the preparation of said polymers.

By way of example of amphiphilic block polymers suitable for implementing the invention, mention may be made of polyhydroxystearate-polyethylene glycol-polyhydroxystearate triblock polymers (the products of the Arlacel range from ICI are an example thereof), and polyalkyl polyether grafted polydimethylsiloxane block polymers (such as the products of the Tegopren brand name sold by Goldschmidt).

Among the cationic amphiphilic polymers and surfactants, use may in particular be made of aliphatic or aromatic fatty amines, quaternary ammonium derivatives (Glokill PQ, Rhodaquat RP50, marketed by Rhodia Chimie), and cationic polymers of the hydrophobic modified polyquaternium type.

Use may similarly be made of cationic derivatives of polysaccharides, such as derivatives of guar or of cellulose.

It is similarly possible to use cationic polymers functionalized with hydrophobic groups such as C₁-C₁₄, preferably C₂-C₈, alkyl chains optionally containing a hydroxyl group. These hydrophobic groups are attached to the main polymer chain via ether bonds.

Moreover, and in the case of modified cationic guars which may or may not be hydrophobic, the cationic group is a quaternary ammonium group bearing three radicals, which may or may not be identical, chosen from hydrogen, and an alkyl radical comprising 1 to 22 carbon atoms, more particularly 1 to 14 carbon atoms, advantageously 1 to 3 carbon atoms. The counter-ion is a halogen, preferably chlorine.

In the case of modified cationic celluloses, which may or may not be hydrophobic, the cationic group is a quaternary ammonium group bearing three radicals, which may or may not be identical, chosen from hydrogen and an alkyl radical comprising 1 to 10 carbon atoms, more particularly 1 to 6 carbon atoms, advantageously 1 to 3 carbon atoms. The counter-ion is a halogen, preferably chlorine.

According to a preferred embodiment of the invention, at least one nonionic amphiphilic polymer is used.

An advantageous variant of this embodiment consists in combining with said polymer, in stage (a), at least one nonionic surfactant.

The total amount of nonionic or cationic surfactant and/or of nonionic or cationic amphiphilic polymer represents more particularly 0.1 to 15% by weight of the internal aqueous phase, preferably from 2 to 10% by weight of the internal aqueous phase.

In accordance with a particularly advantageous embodiment of the present invention, the internal aqueous phase may comprise at least one additive chosen from salts such as alkali metal or alkaline-earth metal halides (for instance sodium chloride or calcium chloride), or alkali metal or alkaline-earth metal sulfates (for instance magnesium sulfate), or mixtures thereof. The internal aqueous phase may also comprise at least [lacuna] additive chosen from sugars, such as glucose for example, or else from polysaccharides, such as in particular dextran, or mixtures thereof.

The salt concentration in the internal aqueous phase, when this salt is present, is more particularly between 0.05 and 1 mol/l, preferably 0.1 to 0.4 mol/l.

The concentration of sugar and/or of polysaccharide is such that the osmotic pressure of the internal aqueous phase comprising the sugar and/or polysaccharide corresponds to the osmotic pressure of an internal aqueous phase comprising 0.05 to 1 mol/l of salt.

In addition, the inverse emulsion of the multiple emulsion has more particularly an internal aqueous phase/internal organic phase weight proportion of between 10/90 and 90/10. Preferably, the internal aqueous phase/internal organic phase weight proportion is between 30/70 and 80/20.

The inverse emulsion is prepared using conventional methods. Thus, to cite just one example, initially, a first mixture comprising water, the hydrophilic active material, where appropriate the surfactant and/or the cationic polymer and, optionally, the additive is prepared and, secondly, a second mixture comprising the hydrophobic compound and optionally the surfactant and/or the amphiphilic polymer is prepared. The first mixture is then added to the second, with stirring.

Usually, the stirring is determined without difficulty by those skilled in the art, and depends in particular on the viscosity of the mixture to be homogenized. Particularly advantageously, the homogenization is carried out by means of a frame paddle. It should, however, be noted that other stirring means using greater pressures are not excluded, even though it is not necessary to use them.

The inverse emulsion is prepared at a temperature greater than or equal to the melting point of the hydrophobic compound. Thus, the temperature for preparing the emulsion occurs at a temperature greater than or equal to 35° C. Moreover, the temperature at which the inverse emulsion is prepared is more particularly less than or equal to 100° C.

The duration of stirring can be determined without difficulty by those skilled in the art, and depends on the type of apparatus used. It is preferably sufficient to obtain an inverse emulsion with a mean droplet size of between 0.1 and 10 μm, preferably between 0.1 and 5 μm (measured using a Horiba granulometer). It is recalled that the mean droplet size corresponds to the median diameter by volume (d50), which represents the diameter of the particle equal to 50% of the cumulative distribution.

The second step of the process by which the suspension according to the invention can be obtained consists in preparing the multiple emulsion by dispersing the inverse emulsion which has just been described in an external aqueous phase (step (b)).

Said external aqueous phase will now be described.

It should be noted that the composition of the internal aqueous phase is preferably different from that of the external aqueous phase.

The external aqueous phase comprises at least one nonionic polyalkoxylated surfactant and/or at least one nonionic polyalkoxylated amphiphilic polymer, and at least one anionic surfactant.

As regards the nonionic polyalkoxylated surfactant or the nonionic polyalkoxylated amphiphilic polymer, and also the anionic surfactant, they are chosen from those which satisfy at the same time the two conditions below:

when they are mixed with the external aqueous phase, at a concentration of between 0.1 and 10% by weight of said phase at 25° C., they are in the form of a solution in all or part of the concentration range indicated;

when they are mixed with the internal organic phase, at a concentration of between 0.1 and 10% by weight of said phase and at 25° C., they are in the form of a dispersion in all or part of the concentration range indicated.

Preferably, the nonionic polyalkoxylated surfactant present in the external aqueous phase has an HLB value greater than or equal to 10.

By way of example of nonionic polyalkoxylated surfactants suitable for implementing the invention, mention may be made, inter alia, of the following surfactants, alone or as mixtures:

alkoxylated fatty alcohols

alkoxylated triglycerides

alkoxylated fatty acids

alkoxylated sorbitan esters

alkoxylated fatty amines

alkoxylated di(1-phenylethyl)phenols

alkoxylated tri(1-phenylethyl)phenols

alkoxylated alkylphenols.

The alkoxylated units are preferably ethoxylated units or a mixture of ethoxylated and propoxylated units.

The surfactants mentioned as being suitable for preparing the inverse emulsion can be repeated, with the exception of the fact that the number of ethoxylated and propoxylated units, if they are present, should be adjusted as a function of the desired HLB value. Purely by way of illustration, the number of ethoxylated and, optionally, propoxylated units is between 10 and 100.

As regards the nonionic amphiphilic polymer, use is made of a polymer comprising at least two blocks, one of them being hydrophilic, the other being hydrophobic.

What was indicated previously in the context of the description of the nonionic hydrophilic monomers and of the hydrophobic monomers which can be used to prepare the amphiphilic block polymers included in the composition of the inverse emulsion remains valid and will not be repeated here. The proportion and the nature of said monomers is such that the resulting polymer satisfies the conditions previously stated (Bancroft rule—two conditions).

According to a particular embodiment, the polymer is obtained from hydrophilic monomers chosen from acrylamide and methacrylamide, alone or as a mixture, or in the form of macromonomers; the preferred hydrophobic monomers are esters of acrylic acid with linear or branched C₁-C₄ alcohols, such as methyl, ethyl, propyl or butyl acrylate, vinyl esters such as vinyl acetate, styrene or α-methylstyrene.

When said polymer comprises at least three blocks, and more particularly three blocks, the polymer is advantageously linear. In addition, the hydrophilic blocks are more particularly at the ends.

When the polymers comprise more than three blocks, these polymers are preferably in the form of grafted or comb polymers.

According to another advantageous embodiment, the amphiphilic polymer comprises polyalkoxylated blocks, and preferably comprises only polyalkoxylated blocks, at least one of which is hydrophobic, the other hydrophilic.

Purely by way of indication, these polymers are obtained using ring-opening polymerizations, in particular anionic polymerizations.

More particularly, said nonionic polyalkoxylated amphiphilic polymers are chosen from polymers whose weight-average molar mass is less than or equal to 100 000 g/mol (measured by GPC, polyethylene glycol standard), preferably between 1 000 and 50 000 g/mol, preferentially between 1 000 and 20 000 g/mol.

By way of example of polymers of this type, mention may be made, inter alia, of polyethylene glycol/polypropylene glycol/polyethylene glycol triblock polymers. Such polymers are well known and are in particular marketed under the brand names Pluronic (marketed by BASFY, and Arlatone (marketed by ICI).

It should be noted that it would not be a departure from the context of the present invention to combine one or more surfactants with one or more amphiphilic polymers.

However, according to a preferred embodiment of the invention, the external aqueous phase comprises one or more amphiphilic polymers.

The content of nonionic polyalkoxylated surfactant and/or of nonionic polyalkoxylated amphiphilic polymer present in the external aqueous phase is more particularly between 0.1 and 10% by weight relative to the weight of the inverse emulsion. Preferably, the content of nonionic surfactant and/or of amphiphilic polymer is between 1 and 5% by weight relative to the weight of the inverse emulsion.

In addition, the weight proportion of inverse emulsion relative to the external aqueous phase is usually between 30/70 and 90/10, preferably between 50/50 and 90/10.

The anionic surfactant represents one of the essential constituent elements of the external aqueous phase.

As regards this surfactant, mention may be made, purely by way of illustration, of the following surfactants:

alkyl ester sulfonates, for example of formula R—CH(SO₃M)-CH₂COOR′, where R represents a C₈-C₂₀, preferably C₁₀-C₁₆, hydrocarbon-based radical optionally bearing one or more unsaturations, R′ represents a C₁-C₆, preferably C₁-C₃, alkyl radical and M represents a hydrogen atom or an alkali metal (sodium, potassium, lithium) cation, or ammonium which is substituted or unsubstituted (methyl-, dimethyl-, trimethyl- or tetramethyl-ammonium, dimethylpiperidinium, etc.) or derived from an alkanolamine (monoethanolamine, diethanolamine, triethanolamine, etc.). Mention may most particularly be made of methyl ester sulfonates in which the R radical is a C₁₄-C₁₆ radical; C₉-C₂₀ alkylbenzenesulfonates, primary or secondary C₈-C₂₂ alkylsulfonates, alkylglycerol sulfonates, the sulfonated polycarboxylic acids described in GB-A-1 082 179, paraffin sulfonates; alkyl ester sulfates, for example of formula R—CH(OSO₃M)-CH₂COOR′, where R represents a C₈-C₂₀, preferably C₁₀-C₁₆, hydrocarbon-based radical optionally bearing one or more unsaturations, R′ represents a C₁-C₆, preferably C₁-C₃, alkyl radical and M has the same definition as above;

alkylsulfates, for example of formula ROSO₃M, where R represents a C₁₀-C₂₄, preferably C₁₂-C₂₀, alkyl or hydroxyalkyl radical; M has the same definition as above; such as, for example, sodium dodecyl sulfate;

alkyl ether sulfates, for example of formula RO(AO)ₙSO₃M, where R represent a C₁₀-C₂₄, preferably C₁₂-C₂₀, alkyl or hydroxyalkyl radical; AO representing an ethoxylated or propoxylated group, or combinations thereof; M has the same definition as above; n ranging generally from 1 to 4, such as, for example, lauryl ether sulfate with n=2;

alkylamide sulfates, for example of formula RCONHR′OSO₃M, where R represents a C₂-C₂₂, preferably C₆-C₂₀, alkyl radical, R′ represents a C₂-C₃ alkyl radical, M has the same definition as above, and also their polyalkoxylated (ethoxylated (EO), propoxylated (PO), or combinations thereof) derivatives;

salts of saturated or unsaturated fatty acids, for instance C₈-C₂₄, preferably C₁₄-C₂₀ fatty acids, N-acyl N-alkyltaurates, alkylisethionates, alkylsuccinamates and alkylsulfosuccinates, sulfosuccinate monoesters or diesters, N-acyl sarcosinates, polyethoxycarboxylates; and

alkyl and/or alkyl ether and/or alkylaryl ether phosphate esters.

The amount of anionic surfactant preferably represents 0.1 to 10% by weight of the content of nonionic polyalkoxylated surfactant and/or of nonionic polyalkoxylated amphiphilic polymer.

Moreover, according to an advantageous embodiment of the present invention, the multiple emulsion comprises at least one polysaccharide or a mixture of polysaccharides.

By way of nonlimiting example of polysaccharides, mention may be made of dextran, starch, maltodextrin, xanthan gum and galactomannans such as guar or carob.

The content of polysaccharide, if it is present, represents 0.1 to 2% of the external aqueous phase, preferably 0.5 to 1.5% by weight of the external aqueous phase.

In addition, the external aqueous phase may comprise at least one preserving agent.

Preferably, and essentially to simplify the preparation of the multiple emulsion, the preserving agent is chosen from compounds soluble at least partially in the external aqueous phase.

By way of example of preserving agents which can be included in the composition of the external aqueous phase, mention may be made, inter alia, of the following compounds: Germaben (Sutton Lab), propylene glycol, diazolidinyl urea, methyl-, ethyl, propyl- and butylparaben; Phenonip (Nipa) phenoxyethanol; Glydant (Lonza) DMDM hydantoin.

If it is present, the content of preserving agent generally represents 0.1 to 2% by weight of the external aqueous phase.

According to a variant of the present invention, the external aqueous phase may comprise a dispersed solid.

All the solids used in the various applications mentioned may be suitable. Preferably, the size of this dispersed solid is in the region of or smaller than that of the droplets of the inverse emulsion.

When the dispersed solid is present, its content represents more particularly 1 to 50% by weight of the external aqueous phase, preferably 5 to 25% by weight.

It should be noted that, in the case of the multiple emulsion according to the invention, and unlike the conventional multiple emulsions, it is not necessary to introduce into the external aqueous phase a compound which makes it possible to equilibrate the osmotic pressures of the internal and external aqueous phases. This represents a definite advantage when the ionic strength of the internal aqueous phase, provided for example by a considerable content of hydrophilic active material in this phase, is so high that it is virtually impossible to be able to adjust the osmotic pressures and still conserve a composition which can be handled.

The multiple emulsion can be prepared according to any known method.

By way of example, the following procedure can be carried out. In a first stage, the external aqueous phase is prepared by mixing the nonionic polyalkoxylated surfactant and/or the nonionic polyalkoxylated amphiphilic polymer, the anionic surfactant, optionally the polysaccharide, and the water.

The external aqueous phase can optionally be left to stand for 1 to 12 hours at ambient temperature.

The multiple emulsion per se is then prepared, by adding the inverse emulsion to the external aqueous phase.

In accordance with a first possible embodiment, the multiple emulsion is obtained with stirring, by adding the inverse emulsion slowly, at the start.

The stirring can be carried out by means of a frame paddle. Typically, the rate of stirring is usually relatively slow, of the order of 400 rpm.

The multiple emulsion is prepared at a temperature greater than or equal to the melting point of the hydrophobic compound of the internal organic phase. Thus, the temperature for preparing the emulsion occurs at a temperature greater than or equal to 35° C. Moreover, the temperature at which the emulsion is prepared is more particularly less than or equal to 100° C.

A second method for preparing the multiple emulsion consists in introducing the external aqueous phase into the inverse emulsion without stirring.

Next, after having introduced all the external aqueous phase into the inverse emulsion, the mixture is stirred.

Advantageously, the stirring is carried out by means of moderate-shear mixers, as are, for example, mixers equipped with a frame paddle, mixers of the planetary type, or else those having a scraping rotor and a paddle rotating in opposite directions. (counter-stirring).

This stirring operation takes place at a temperature greater than the melting point of the compound constituting the internal organic phase.

At the end of this stirring step, a concentrated multiple emulsion is obtained, in which the inverse emulsion/external aqueous phase weight ratio is between 50/50 and 90/10, and preferably between 70/30 and 90/10.

Depending on the applications, a further optional step consisting of dilution can be envisioned.

It is carried out by adding, with stirring, an aqueous diluting phase comprising at least one surfactant and/or at least one polymer present in the external aqueous phase, and which are preferably the same as those present in the external phase of the concentrated multiple emulsion.

Preferably, the amount of external surfactant and/or amphiphilic polymer in the aqueous diluting phase is such that the amount of external surfactant and/or amphiphilic polymer is within the ranges previously indicated (the proportions being expressed relative to the entire combination of aqueous diluting phase and external aqueous phase of the concentrated multiple emulsion).

It should be noted that the amount of diluting water is advantageously such that the weight ratio of inverse emulsion/external aqueous phase of the diluted multiple emulsion is within the ranges previously mentioned.

This process has in particular been the subject of a French patent application FR 01 15982 filed on Dec. 11, 2001.

The mean droplet size (d50) of the multiple emulsion advantageously varies between 0.1 and 100 μm, more particularly between 1 and 50 μm, preferably between 5 and 30 μm (measured using a Horiba granulometer).

Step (c) consists in bringing the multiple emulsion thus obtained to a temperature less than the melting point of the hydrophobic compound. Advantageously, the temperature of the multiple emulsion at the end of this step is ambient temperature.

It should be noted that the cooling can be carried out in a controlled manner or by leaving the emulsion to cool down.

At the end of this step, the multiple emulsion has the appearance of a paste.

The mean size of the particles of the suspension (d50) is preferably between 0.1 and 100 μm, more particularly between 1 and 50 μm, preferably between 5 and 30 μm (measured using a Horiba granulometer). It should be noted that the mean size of the droplets of the multiple emulsion and that of the particles of the suspension are similar. More especially, this cooling step does not have the effect of causing the particles to substantially coalesce with one another.

When the external aqueous phase comprises a dispersed solid, the multiple emulsion can be obtained as indicated above, and then said solid dispersed in an aqueous phase preferably having the same composition as the external phase of the multiple emulsion is added to the concentrated or diluted multiple emulsion obtained. It is, moreover, understood that the amount of external aqueous phase introduced with the multiple emulsion and the dispersed solid is such that the concentration ranges indicated previously are satisfied.

As indicated previously, another subject of the invention consists of granules which can be obtained from the suspension which has just been described.

Thus, the suspension is brought into contact, in a step (d), with at least one drying agent.

The term “drying agent” denotes any porous compound capable of absorbing large amounts of water.

Among the drying agents which can be used, mention may be made, without the intention of being limited thereto, of silica, clays such as bentonite, montmorillonite, kaolin, calcium carbonate and calcium phosphate, alone or as a mixture.

The amount of drying agent is determined as a function of various criteria, among which are the desired appearance of the multiple emulsion after the bringing into contact with the drying agent, conditions for a possible further drying step.

By way of illustration, the content of drying agent added represents more particularly 5 to 40% by weight of the multiple emulsion.

The multiple emulsion and the drying agent are brought into contact in a conventional manner, with stirring.

The aim pursued is, in the context of this step, to remove most of the water originating from the external aqueous phase. It should be noted that the result of this drying step is to conserve virtually all (purely by way of illustration, more than approximately 90%) the water originating from the internal aqueous phase.

At the end of this step, the granules obtained advantageously have a mean particle size of between 100 μm and 5 mm.

According to a particular and preferred variant of the invention, an additional drying step is carried out, once step (c) has been carried out, at a temperature less than the melting point of the hydrophobic compound present in the internal organic phase.

This additional drying operation is usually carried out in a stream of air or of any other inert gas (nitrogen, etc.).

This drying can be carried out by any means known to those skilled in the art. Advantageously, said drying is carried out in an incubator or by means of a fluidized bed.

The aim of this additional drying step is to continue the drying carried out by means of the drying agent, while at the same time here again conserving virtually all the water originating from the internal aqueous phase.

It should be noted that the mean size of the granules obtained at the end of this additional drying step and that of the granules obtained at the end of the drying with the drying agent are similar, or even virtually identical. Thus, the mean size is between 100 μm and 5 mm.

At the end of the process, granules are obtained which can, if necessary, be the subject of a subsequent implementation, such as an agglomeration step.

As was indicated previously, the suspension, like the granules, according to the invention can be included in the composition of formulations intended to be used in many fields, such as those of cosmetics, dental hygiene, foodstuffs, plant-care, the exploitation of oil or gas fields, and papermaking.

By way of examples of compositions in which the suspension and/or the granules according to the invention can be used as additive, mention may be made of formulations for the skin, the hair, the eyelashes and/or the nails, conditioners, formulations for styling hair and for making it easier to comb hair, lotions for the hands and the body, products regulating moisturization of the skin, toilet milks, make-up-removing compositions, hair-removing products, creams and lotions for protection against the sun and ultraviolet radiation, care creams, anti-acne preparations, make-up formulations such as mascaras, foundations, blush, nail varnish, products intended to be applied to the lips, etc.

Toothpastes may similarly comprise the suspension and/or the granules according to the invention.

The latter may also be included in the composition of formulations for cementation of oil or gas wells.

It should be noted that the suspension and the granules according to the invention are most particularly suitable if it is desired to have a rapid release of the hydrophilic active material, triggered by a temperature greater than or equal to the melting point of the hydrophobic compound of the internal organic phase. This type of condition is in particular found when compositions for cementation of oil or gas wells are used.

The suspension and the granules according to the invention are similarly very advantageous in the sense that they allow a slow release of the active material under certain conditions, when the temperature for use of the formulation into which they are introduced is less than the melting point of the hydrophobic compound of the internal organic phase.

A concrete but nonlimiting example of the invention will now be presented.

### EXAMPLE

1/ Inverse Emulsion

Composition of the Inverse Emulsion:

* 60% of aqueous phase comprising a solution of lithium chloride at 450 g/l;

* 40% of oil phase (beeswax and surfactant) comprising 5% of surfactant Arlacel P135 (ICI—Uniquema (*); % expressed as weight relative to the weight of the aqueous phase) and 5% by weight of Alkamuls S80 (Rhodia Chimie (**); % expressed in weight relative to the weight of the aqueous phase).

(*) Arlacel P135: Polyhydroxystearate—PEG—polyhydroxystearate: HLB=5-6;

Mw [illegible] 5 000 g/mol).

(**) Alkamuls S80: sorbitan monooleate.

Preparation of the Inverse Emulsion

100 g of inverse emulsion are prepared.

3 g of Arlacel P135, 3 g of Alkamuls S80 and 34 g of beeswax chips are introduced into a metal beaker, and the entire mixture is then heated to 75° C. The molten mixture is then homogenized in a Ultra-turrax at 9 500 rpm.

60 g of solution of lithium chloride at 450 g/l are weighed into a beaker and this solution is heated to approximately 70° C.

The solution of lithium chloride is added dropwise to the molten organic phase previously obtained, with stirring (Ultra-turrax; 9 500 rpm). Once it has all been added, the stirring is maintained for a further 2 minutes.

2/ Multiple Emulsion

Composition of the Multiple Emulsion:

* 50% of inverse emulsion (comprising 2% of lithium chloride; expressed relative to the total weight of the emulsion)

* 50% of external aqueous phase containing:

2% of Arlatone F127G (*) (ICI—Uniquema; % by weight expressed relative to the weight of the inverse emulsion);

5% of sodium dodecyl sulfate (% by weight expressed relative to the weight of Arlatone F127G);

1% of Rhodopol 23 (**) (Rhodia Chimie; % by weight expressed relative to the weight of the inverse emulsion).

(*) Arlatone F127G: HO(CH₂CH₂O)ₓ(OCH(CH₃)CH₂O)_{y}(CH₂CH₂O)_{z}H with the following inequation being satisfied:

82<x+z<90 and the polymer comprises 7 PO units per mole of product).

(**) Rhodopol 23: xanthan gum.

Preparation of the Multiple Emulsion

Preparation of the External Aqueous Phase:

100 g of external aqueous phase are prepared.

50 g of solution of Arlatone F127G and of sodium dodecyl sulfate are weighed out. 50 g of solution of Rhodopol 23 at 2% in water are weighed out.

The entire combination is mixed with a frame paddle at 200 rpm, at a temperature between 70 and 75° C.

Preparation of the Multiple Emulsion:

The 100 g of the inverse emulsion obtained in point 1/are introduced, with stirring using a frame paddle at 600 rpm, dropwise, into the external aqueous phase, at a temperature of between 10 and 75° C.

3/ Drying the Multiple Emulsion

An amount of multiple emulsion is weighed out, to which 30% by weight of silica (Zeosil 1165 MP; marketed by Rhodia Chimie) relative to the weight of multiple emulsion is added.

A composition having the appearance of a sandy paste is obtained.

The paste thus obtained is then placed in an incubator at 40° C. for 12 hours.

The resulting granules are stable when stored.

1. A suspension of particles in an aqueous medium, characterized in that it can be obtained by carrying out the following steps:
(a) a water-in-oil inverse emulsion is prepared from an internal aqueous phase comprising at least one hydrophilic active material, and an internal organic phase comprising at least one hydrophobic compound having a melting point of greater than or equal to 35° C., at least one nonionic or cationic surfactant and/or at least one nonionic or cationic amphiphilic polymer; the temperature for preparing the emulsion being greater than or equal to the melting point of the hydrophobic compound;
(b) the multiple emulsion is prepared by dispersing the inverse emulsion in an external aqueous phase comprising at least one nonionic polyalkoxylated surfactant and/or at least one nonionic polyalkoxylated amphiphilic polymer and at least one anionic surfactant; the temperature at which the dispersion is carried out being greater than or equal to the melting point of the hydrophobic compound;
(c) the multiple emulsion obtained is brought to a temperature less than or equal to the melting point of the hydrophobic compound.

2. The suspension as claimed in the preceding claim, characterized in that the mean size of the particles of the suspension is between 0.1 and 100 μm, more particularly between 1 and 50 μm, preferably between 5 and 30 μm.

3. The suspension as claimed in either of the preceding claims, characterized in that the hydrophilic active material is chosen from the following:
+ cosmetics field: α-hydroxy acids; hydrophilic vitamins; biocides, moisturizers;
+ food sector: crosslinking agents for texturing polymers, such as divalent calcium salts;
+ field of plant-care: hydrophilic pesticides, hydrophilic nutritive elements which promote plant growth and development;
+ field of the exploitation or construction of oil or gas wells: hydrophilic active materials which can be used during operations of cementation, completion, drilling and stimulation of wells, such as catalysts for crosslinking of cement-based compositions; compounds capable of degrading polysaccharides, such as carboxylic acids, enzymes or oxidants;
+ field of silicones: crosslinking agents such as calcium salts;
+ papermaking field: calcium chloride, hydrochloric acid.

4. The suspension as claimed in one of the preceding claims, characterized in that the total amount of hydrophilic active material is between 0.1 and 70% by weight of the internal aqueous phase, preferably between 0.1 and 50% by weight of the internal aqueous phase.

5. The suspension as claimed in one of the preceding claims, characterized in that the hydrophobic compound has a melting point of less than or equal to 100° C.

6. The suspension as claimed in one of the preceding claims, characterized in that the hydrophobic compound is chosen from:
+ waxes or fats of animal or plant origin, mineral waxes;
+ saturated or unsaturated C₁₄-C₄₀ mono- or polycarboxylic acids, optionally comprising one or more hydroxyl groups; mono- or polyesters of C₁₄-C₄₀ mono- or polycarboxylic acids, optionally comprising one or more hydroxyl groups; saturated or unsaturated mono- or polyalcohols, comprising 14 to 40 carbon atoms;
+ synthetic resins or gums such as silicone gums or resins, alkyd resins or epoxy resins; tackifying resins.

7. The suspension as claimed in one of the preceding claims, characterized in that the nonionic surfactant and/or the nonionic amphiphilic polymer present in the internal organic phase is (are) chosen from those which satisfy at the same time the two conditions below:
when they are mixed with the internal organic phase, at a concentration of between 0.1 and 15% by weight of said phase at 25° C., they are in the form of a solution in all or part of the concentration range indicated;
when they are mixed with the internal aqueous phase, at a concentration of between 0.1 and 15% by weight of said phase and at 25° C., they are in the form of a dispersion in all or part of the concentration range indicated.

8. The suspension as claimed in one of the preceding claims, characterized in that at least one nonionic amphiphilic polymer combined with at least one nonionic surfactant is used in step (a).

9. The suspension as claimed in one of the preceding claims, characterized in that the amount of nonionic or cationic surfactant and/or of nonionic or cationic amphiphilic polymer represents 0.1 to 10% by weight of the internal aqueous phase, preferably from 2 to 10% by weight of the internal aqueous phase.

10. The suspension as claimed in one of the preceding claims, characterized in that the multiple emulsion has an aqueous phase/organic phase weight proportion of between 10/90 and 90/10, preferably between 30/70 and 80/20.

11. The suspension as claimed in one of the preceding claims, characterized in that the nonionic polyalkoxylated surfactant and/or the nonionic polyalkoxylated amphiphilic polymer, and also the anionic surfactant, present in the external aqueous phase is(are) chosen from those which satisfy at the same time the two conditions below:
when they are mixed with the external aqueous phase, at a concentration of between 0.1 and 10% by weight of said phase at 25° C., they are in the form of a solution in all or part of the concentration range indicated;
when they are mixed with the internal organic phase, at a concentration of between 0.1 and 10% by weight of said phase and at 25° C., they are in the form of a dispersion in all or part of the concentration range indicated.

12. The suspension as claimed in one of the preceding claims, characterized in that the content of nonionic polyalkoxylated surfactant and/or of nonionic polyalkoxylated amphiphilic polymer present in the external aqueous phase is between 1 and 10% by weight relative to the weight of the inverse emulsion, preferably between 1 and 5% by weight of the inverse emulsion.

13. The suspension as claimed in one of the preceding claims, characterized in that the amount of anionic surfactant represents 0.1 to 10% by weight of the content of nonionic polyalkoxylated surfactant and/or of nonionic polyalkoxylated amphiphilic polymer.

14. The suspension as claimed in one of the preceding claims, characterized in that the weight proportion of inverse emulsion relative to the external aqueous phase is usually between 30/70 and 90/10, preferably between 50/50 and 90/10.

15. The suspension as claimed in one of the preceding claims, characterized in that the external aqueous phase comprises at least one polysaccharide or a mixture of polysaccharides, with a content representing 0.1 to 2% of the external aqueous phase, preferably 0.5 to 1.5% by weight of the external aqueous phase.

16. The suspension as claimed in one of the preceding claims, characterized in that the external aqueous phase comprises at least one preserving agent, with a content representing 0.1 to 1% by weight of the external aqueous phase.

17. The suspension as claimed in one of the preceding claims, characterized in that the external aqueous phase comprises a dispersed solid, with a content representing 1 to 50% by weight of the external aqueous phase, preferably 5 to 25% by weight of the external aqueous phase.

18. A granule which can be obtained by drying a suspension as claimed in one of the preceding claims, consisting in bringing the suspension as claimed in one of the preceding claims into contact with at least one drying agent, in a step (d).

19. The granule as claimed in the preceding claim, characterized in that the drying agent is chosen from silica, clays, calcium carbonate and calcium phosphate, alone or as a mixture.

20. The granule as claimed in either of claims 18 and 19, characterized in that the content of drying agent represents 5 to 40% by weight of the suspension.

21. The granule as claimed in one of claims 18 to 20, characterized in that, after step (d), a drying step is carried out at a temperature less than the melting point of the hydrophobic compound.

22. The granule as claimed in the preceding claim, characterized in that the drying is carried out in an incubator or by means of a fluidized bed.

23. The granule as claimed in one of claims 18 to 22, characterized in that the granules have a mean size of between 100 μm and 5 mm.

24. The use of the suspension as claimed in any one of claims 1 to 17, as additive in formulations intended for the fields of cosmetics, dental hygiene, foodstuffs, plant-care, the exploitation of oil or gas fields, and papermaking.

25. The use of the granule as claimed in any one of claims 18 to 23, as additive in formulations intended for the fields of cosmetics, dental hygiene, foodstuffs, plant-care, the exploitation of oil or gas fields, and papermaking.

26. A formulation intended for the fields of cosmetics, dental hygiene, foodstuffs, plant-care, the exploitation of oil or gas fields, and papermaking, comprising, as additives, the suspension as claimed in one of claims 1 to 17.

27. A formulation intended for the fields of cosmetics, dental hygiene, foodstuffs, plant-care, the exploitation of oil or gas fields, and papermaking, comprising, as additives, the granule as claimed in any one of claims 18 to 23.
